(19) United States
(12) Patent Application Publication
(10) Pub. No.: US 2010/0072822 A1
(43) Pub. Date: Mar. 25, 2010

(54) Power Supply System and Related Method and Related Portable Electronic Device

(76) Inventor: Chin-Yu Wang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/556,580

(22) Filed: Sep. 10, 2009

(30) Foreign Application Priority Data
Sep. 25, 2008 (TW) 097136823

(51) Int. Cl. H02J 1/00

(52) U.S. Cl. 307/80

(57) ABSTRACT

A power supply system installed in a portable electronic apparatus includes a plurality of receiving ends, a selection unit, a power control unit, and a power converting unit. The plurality of receiving ends is coupled to a plurality of power sources of the portable electronic apparatus. The selection unit is coupled to the plurality of receiving ends for selecting an input power from the plurality of power sources. The power control unit is utilized for generating an output power control signal according to an input signal. The power converting unit is utilized for converting the input power into an output power to a power port according to the output power control signal.

### BACKGROUND OF THE INVENTION

1. Field of the Invention

The present invention relates to a power supply system, related method, and related portable electronic device, and more particularly, to a power supply system, related method, and related portable electronic device capable of utilizing power energy of a portable electronic device for providing the power for an external apparatus.

2. Description of the Prior Art

With technological advancement, a portable electronic device, such as a notebook computer, a personal digital assistant, a mobile phone, a digital camera, a multimedia player, and a game console, etc., has several advantages, including small size, light weight, and convenience for carrying due to its portability, and provides powerful computation abilities and document or multimedia processing functions anywhere and anytime, allowing a user to work in any location outside an office or enjoy multimedia interaction on the go. To facilitate a user to carry a portable electronic device, the portable electronic device is equipped with a rechargeable battery for providing operating power. As the power of the rechargeable battery is run out, the rechargeable battery needs to be recharged.

Furthermore, a user nowadays often carries two or more portable electronic devices. However, each electronic device has its dedicated recharging specification (such as voltages or currents). Therefore, the user needs to carry some dedicated recharging apparatus for various portable electronic devices and this is inconvenient for the user.

### SUMMARY OF THE INVENTION

It is therefore a primary objective of the claimed invention to provide a power supply system and related method and related portable electronic device.

The present invention discloses a power supply system installed in a portable electronic apparatus. The power supply system includes a plurality of receiving ends, a selection unit, a power control unit, and a power converting unit. The plurality of receiving ends is coupled to a plurality of power sources of the portable electronic apparatus. The selection unit is coupled to the plurality of receiving ends for selecting an input power from the plurality of power sources. The power control unit is utilized for generating an output power control signal according to an input signal. The power converting unit is utilized for converting the input power into an output power to a power port according to the output power control signal.

The present invention further discloses a power supply method for a portable electronic apparatus. The power supply method comprises receiving a plurality of power sources of the portable electronic apparatus, selecting an input power from the plurality of power sources, generating an output power control signal according to an input signal, and converting the input power into an output power to a power port according to the output power control signal.

The present invention further discloses a portable electronic apparatus. The portable electronic apparatus comprises a plurality of power sources, a power port, and a power supply system. The plurality of power sources are utilized for providing operating power of the portable electronic apparatus. The power supply system is coupled to the plurality of power sources and the power port for providing an output power to the external of the portable electronic apparatus, wherein the power supply system comprises a plurality of receiving ends, a selection unit, a power control unit, and a power converting unit. The plurality of receiving ends is respectively coupled to the plurality of power sources. The selection unit is coupled to the plurality of receiving ends for selecting an input power. The power control unit is utilized for generating an output power control signal according to an input signal. The power converting unit is coupled to the selection unit and the power control unit for converting the input power into the output power to the power port according to the output power control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a portable electronic apparatus according to an embodiment of the present invention.

FIG. 2 is a schematic diagram of a power supply system according to an embodiment of the present invention.

FIG. 3 is a schematic diagram of a power supplying procedure of the portable electronic apparatus shown in FIG. 1 according to an embodiment of the present invention.

### DETAILED DESCRIPTION

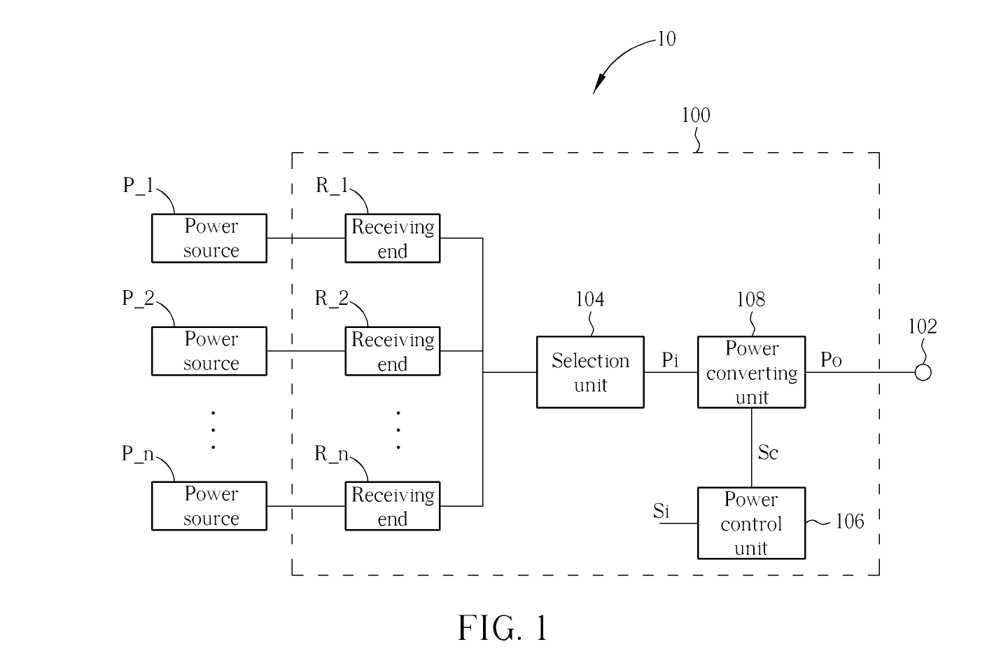

Please refer to the FIG. 1. FIG. 1 is a schematic diagram of a portable electronic apparatus 10 according to an embodiment of the present invention. The portable electronic apparatus 10 is preferably a notebook or a personal digital assistant, which can flexibility provide power energy to its exterior, but is not a limitation of the present invention. The portable electronic apparatus 10 includes a plurality of power sources P_1˜P_n, a power port 102, and a power supply system 100. The power sources P_1˜P_n are utilized for providing operating power of the portable electronic apparatus 10. The power supply system 100 is coupled to the plurality of power sources P_1_{1˜P}_n and the power port 102 for providing an output power Po to the external of the portable electronic apparatus 10. The power supply system comprises a plurality of receiving ends R_1˜R_n, a selection unit 104, a power control unit 106, and a power converting unit 108. The plurality of receiving ends R_1˜R_n are coupled to a plurality of power sources P_1˜P_n for receiving the plurality of power sources P_1˜P_n and transmitting to the selection unit 104. The selection unit 104 is capable of selecting one power source as an input power Pi from the plurality of power sources P_1˜P_n and transmitting the input power Pi to the power converting unit 108. The power control unit 106 is utilized for generating an output power control signal Sc to the power converting unit 108 according to an input signal Si. The power converting unit 108 is utilized for converting the input power Pi into an output power Po to a power port 102 according to the output power control signal Sc.

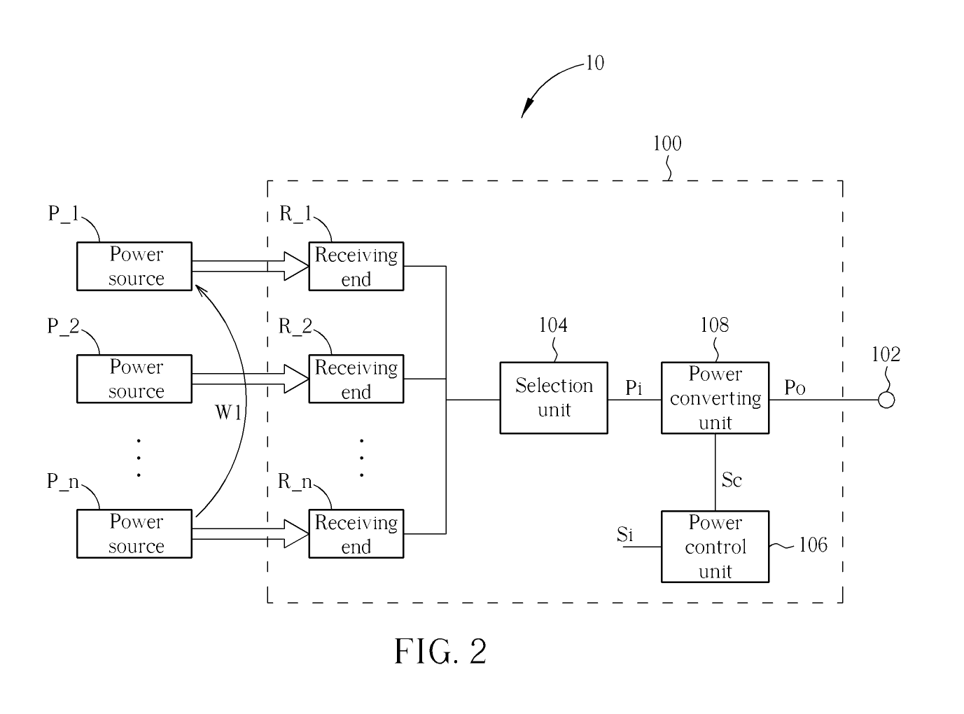

In the embodiment of the present invention, the power supply system 100 can obtain the power energy of the portable electronic apparatus 10 and transform the power energy into the power required by the external apparatus, so that the portable electronic apparatus 10 is capable of providing power for the external apparatus. Preferably, the selection unit 104 is capable of selecting one power source (such as P_1), which is being used by the portable electronic apparatus 10, as the input power Pi from the plurality of power sources P_1˜P_n when the portable electronic apparatus 10 is operating in a working state. Besides, the selection unit 104 is preferably capable of selecting one power source (such as P_2), which is not being used by the portable electronic apparatus 10, as the input power Pi from the plurality of power sources P_1˜P_n when the portable electronic apparatus 10 is operating in a working state. Otherwise, as the portable electronic apparatus 10 is operating in a shut down state, all the power of the portable electronic apparatus 10 may be stopped from being supplied due to default power management function. For example, please refer to the FIG. 2. FIG. 2 is a schematic diagram of the power supply system 100 according to an embodiment of the present invention. Suppose the power source P_1 is a battery of the portable electronic apparatus 10, and the power source P_n is an external AC power source. The portable electronic apparatus 10 may stop supplying power to the internal elements due to default power management function when the portable electronic apparatus 10 is operating in an S5 sleeping state. Therefore, the power source P_n is capable of charging the power source P_1 as shown in the FIG. 2 (path W1). In such a situation, the selection unit 104 can select any of the plurality of power sources P_2˜P_n as the input power Pi for the power converting unit 108 in order to convert the input power Pi into an output power Po to a power port 102.

Therefore, in an embodiment of the present invention, the portable electronic apparatus 10 can be utilized for a recharging source, enhancing user's convenience of use, and more importantly, the power of the portable electronic apparatus 10 can be real-time utilized for operating other apparatus in emergency.

Note that, the portable electronic apparatus 10 is an exemplary embodiment of the present invention, and those skilled in the art can make alternations and modifications accordingly. For example, the plurality of power sources P_1˜P_n is utilized for providing operating power of the portable electronic apparatus 10. Any type of power source which can be provided for the operating power of the portable electronic apparatus 10 is suitable, such as an external AC power source, a battery, etc. The input power Si is preferably generated by a switch or an input device of the portable electronic apparatus 10, so as to indicate power specification required by the external apparatus. In addition, the power control unit 106 can be implemented in a hardware circuit, firmware or software. In such a situation, the input signal Si can be a digital signal, so that the power control unit 106 can set programmable voltages and currents of the output power.

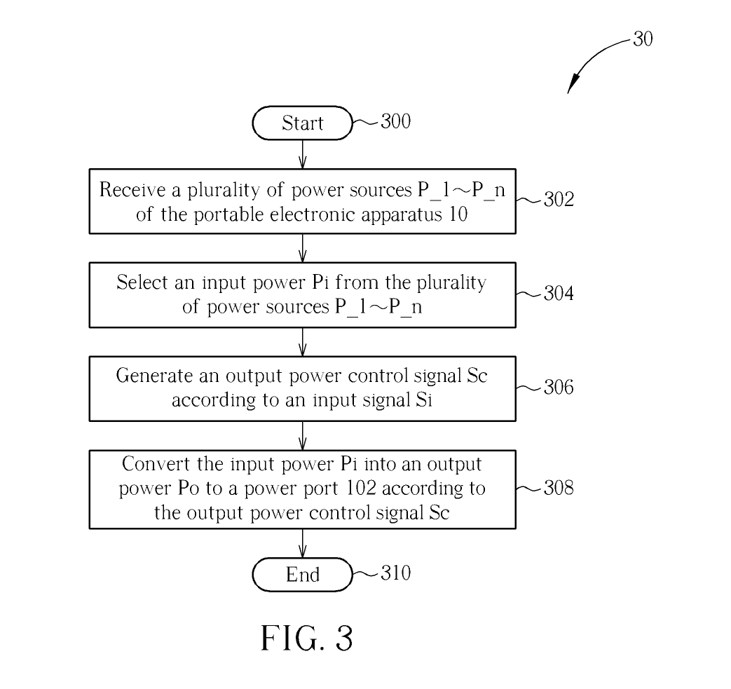

As to an operating procedure of the portable electronic apparatus 10 shown in FIG. 1, please refer to FIG. 3. FIG. 3 is a schematic diagram of a power supplying procedure 30 of the portable electronic apparatus 10 shown in FIG. 1 according to an embodiment of the present invention. The procedure 30 comprises the following steps:

Step 300: Start.

Step 302: Receive a plurality of power sources P_1˜P_n of the portable electronic apparatus 10.

Step 304: Select an input power Pi from the plurality of power sources P_1˜P_n.

Step 306: Generate an output power control signal Sc according to an input signal Si.

Step 308: Convert the input power Pi into an output power Po to a power port 102 according to the output power control signal Sc.

Step 310: End.

According to the procedure 30, the embodiment of the present invention can receive the plurality of power sources P_1˜P_n of the portable electronic apparatus 10, and select an input power Pi from the plurality of power sources P_1˜P_n. The power control unit 106 can generate an output power control signal Sc according to an input signal Si. After that, the power converting unit 108 can convert the input power Pi into an output power Po to a power port 102 according to the output power control signal Sc, so as to flexible provide power required by the external apparatus of the portable electronic apparatus 10.

In summary, the embodiment of the present invention can utilize the portable electronic apparatus 10 for a recharging source, enhancing user's convenience of use, and more importantly, the power of the portable electronic apparatus 10 can be real-time utilized for operating other apparatus in emergency.

Those skilled in the art will readily observe that numerous modifications and alterations of the device and method may be made while retaining the teachings of the invention.

What is claimed is:

1. A power supply system, installed in a portable electronic apparatus, the power supply system comprising:
a plurality of receiving ends coupled to a plurality of power sources of the portable electronic apparatus;
a selection unit coupled to the plurality of receiving ends for selecting an input power from the plurality of power sources;
a power control unit for generating an output power control signal according to an input signal; and
a power converting unit coupled to the selection unit and the power control unit for converting the input power into an output power to a power port according to the output power control signal.

2. The power supply system of the claim 1, wherein the selection unit selects a power source of the plurality of power sources being used by the portable electronic apparatus for the input power when the portable electronic apparatus is operating in a working state.

3. The power supply system of the claim 1, wherein the selection unit selects a power source of the plurality of power sources not being used by the portable electronic apparatus for the input power when the portable electronic apparatus is operating in a working state.

4. The power supply system of the claim 1, wherein the selection unit selects any of the plurality of power sources for the input power when the portable electronic apparatus is operating in a shut down state.

5. The power supply system of the claim 1, wherein the input signal is generated by a switch.

6. The power supply system of the claim 1, wherein the input signal is generated by an input device.

7. The power supply system of the claim 1, wherein the power control unit is further utilized for controlling voltages and currents of the output power according to the output power control signal.

8. A power supply method for a portable electronic apparatus, the power supply method comprising:
receiving a plurality of power sources of the portable electronic apparatus;
selecting an input power from the plurality of power sources;
generating an output power control signal according to an input signal; and
converting the input power into an output power to a power port according to the output power control signal.

9. The power supply method of the claim 8, wherein selecting a power source of the plurality of power sources being used by the portable electronic apparatus for the input power when the portable electronic apparatus is operating in a working state.

10. The power supply method of the claim 8, wherein selecting a power source of the plurality of power sources being not used by the portable electronic apparatus for the input power when the portable electronic apparatus is operating in a working state.

11. The power supply method of the claim 8, wherein selecting any of the plurality of power sources for the input power when the portable electronic apparatus is operating in a shut down state.

12. The power supply method of the claim 8, wherein the output power control signal is utilized for controlling voltages and currents of the output power.

13. A portable electronic apparatus, comprising:
a plurality of power sources for providing operating power of the portable electronic apparatus;
a power port; and
a power supply system coupled to the plurality of power sources and the power port for providing an output power to the external of the portable electronic apparatus, wherein the power supply system comprises:
a plurality of receiving ends coupled to the plurality of power sources;
a selection unit coupled to the plurality of receiving ends for selecting an input power;
a power control unit for generating an output power control signal according to an input signal; and
a power converting unit coupled to the selection unit and the power control unit for converting the input power into the output power to the power port according to the output power control signal.

14. The portable electronic apparatus of claim 13, wherein the plurality of power sources comprises an external power of the portable electronic apparatus.

15. The portable electronic apparatus of claim 13, wherein the plurality of power sources comprises a battery of the portable electronic apparatus.

16. The portable electronic apparatus of claim 13, wherein the selection unit selects a power source of the plurality of power sources being used by the portable electronic apparatus for the input power when the portable electronic apparatus is operating in a working state.

17. The portable electronic apparatus of claim 13, wherein the selection unit selects a power source of the plurality of power sources not being used by the portable electronic apparatus for the input power when the portable electronic apparatus is operating in a working state.

18. The portable electronic apparatus of claim 13, wherein the selection unit selects any of the plurality of power sources for the input power when the portable electronic apparatus is operating in a shut down state.

19. The portable electronic apparatus of claim 13, wherein the input signal is generated by a switch of the portable electronic apparatus.

20. The portable electronic apparatus of claim 13, wherein the input signal is generated by an input device of the portable electronic apparatus.

21. The portable electronic apparatus of claim 13, wherein the power control unit is further utilized for controlling voltages and currents of the output power according to the output power control signal.
